(19) United States
(12) Patent Application Publication
(10) Pub. No.: US 2014/0066825 A1
(43) Pub. Date: Mar. 6, 2014

(54) Handheld Pain Reliever

(71) Applicant: Roger CHEN, New Taipei City (TW)

(72) Inventor: Roger CHEN, New Taipei City (TW)

(21) Appl. No.: 13/603,649

(22) Filed: Sep. 5, 2012

(51) Int. Cl. A61H 1/00

(52) U.S. Cl. 601/46

(57) ABSTRACT

A handheld pain reliever includes a hollow handle, a presser bar having an end piece extended from a rear end of a connection rod thereof inserted into the handle and a presser ring provided with protruding portions connected to a front end of the connection rod at an angle, a vibrator mounted inside the handle for vibrating the presser bar, a rechargeable battery mounted inside the handle adjacent to provide the necessary working voltage to the vibrator, and an on/off switch mounted at the handle and operable to switch on/off the vibrator.

### BACKGROUND OF THE INVENTION

1. Field of the Invention

The present invention relates to medical implements and more particularly, to a handheld pain reliever for vibrating an affected area of a patient to relive pain.

2. Description of the Related Art

Today's dental technology has been mature, unlike the rough techniques of early dental clinics. However, many people still fear the dentist today. Even an over mature age adult may uneasy or nervous when sitting on the consultation chair. When going to inject the medicine in the patient's mouth during a dental treatment, patient's fear may arise.

In order to reduce the patient's anxiety and fear, the most common method is to let the patient inhale a nitrous oxide and oxygen mixture before surgery, making the patient calm down and relax. Thus, the patient's pain can be reduced when taking an injection of local anesthetics or drugs. However, not every dental clinic can afford to buy a nitrous oxide and oxygen mixture supply equipment. Further, a potential crisis exists in using this kind of equipment, not suitable for setting in a human streamlined clinic.

In order to reduce patient anxiety in an injection or follow-up treatment, U.S. Pat. No. 7,981,071 discloses a handheld instrument 10, which comprises a main body 102 accommodating therein a vibrator, and a detachable tip cantilever 101 mounted on the main body 102 to vibrate with it. The detachable tip cantilever 101 can be placed in proximity to, adjacent to and bracketing a preselected injection site on a human or animal and the tissue at said preselected injection site and vibrated while an injection is given.

The aforesaid handheld instrument is convenient for use, however, the detachable tip cantilever is specifically designed for placing a particular injection site on a human, not practical for other body areas. Further, the applied vibrating force may lead to an injection offset. Improvement in this regard is desired.

### SUMMARY OF THE INVENTION

The present invention has been accomplished under the circumstances in view. It is one object of the present invention to provide a handheld pain reliever is pressable on a patient's affected area and controlled to transfer vibrating waves to the patient's affected area so that a physician can inject a medicine to the patient's affected area without causing much pain.

To achieve this and other objects of the present invention, a handheld pain reliever comprises a hollow handle, which comprises an insertion hole located on a front end thereof and a rear opening located on a rear end thereof, a presser bar, which comprises a connection rod, an end piece axially extended from one end of the connection rod and inserted into the insertion hole of the hollow handle, a presser ring connected to an opposite end of the connection rod at an angle for pressing on an affected area of a patient and a plurality of protruding portions protruded from a front side of the presser ring, a vibrator, which is mounted inside the hollow handle, comprising a front accommodation hole kept in axial alignment with the insertion hole of the hollow handle and adapted for receiving the end piece of the presser bar for enabling the presser bar to be vibrated by the vibrator, a rechargeable battery mounted inside the hollow handle adjacent to the rear opening and adapted for providing electricity to the vibrator, and an on/off switch mounted at the hollow handle and electrically connected with the vibrator and the rechargeable battery and operable to switch on/off the vibrator.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 illustrates a handheld pain reliever according to the prior art.

FIG. 2 is an exploded view of a handheld pain reliever in accordance with the present invention.

FIG. 3 is a perspective view of the handheld pain reliever in accordance with the present invention.

FIG. 4 is a front view of the handheld pain reliever in accordance with the present invention.

FIG. 5 is a schematic drawing illustrating an operation status of the handheld pain reliever in accordance with the present invention.

FIG. 6 is a schematic applied view of the handheld pain reliever in accordance with the present invention.

FIG. 7 is an elevational view of an alternate form of the handheld pain reliever in accordance with the present invention.

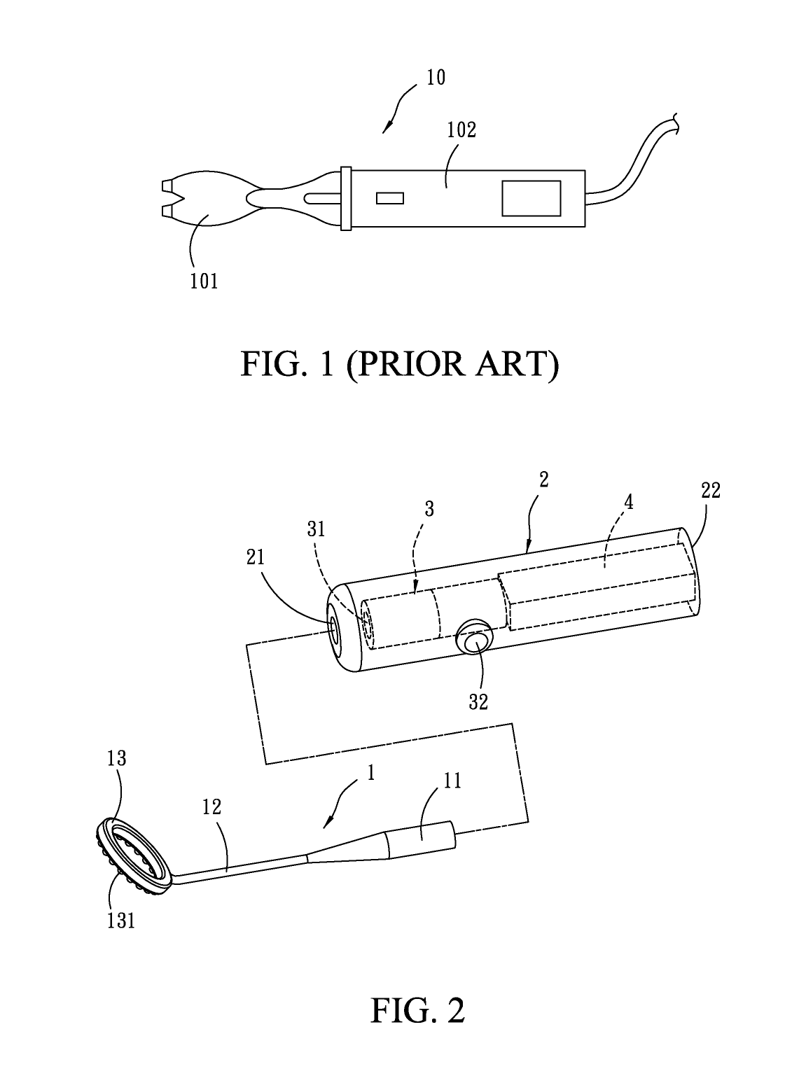

### DETAILED DESCRIPTION OF THE PREFERRED EMBODIMENT

Referring to FIG. 2, a handheld pain reliever in accordance with the present invention is a shown. As illustrated, the handheld pain reliever comprises a pressure bar 1, a handle 2, a vibrator 3, an on/off switch 32, and a rechargeable battery 4.

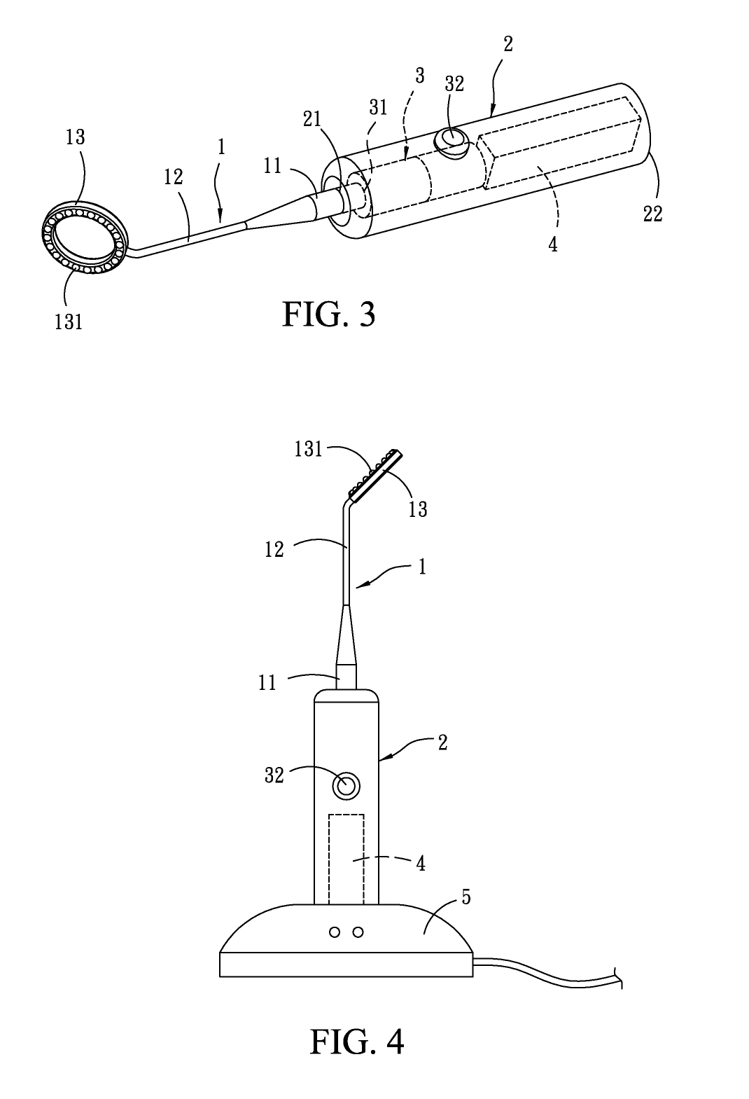

Referring to FIG. 3 and FIG. 2 again, the presser bar 1 is an elongated rod member connected to one end of the handle 2, comprising a connection rod 12 shaped like a narrow elongated round pin, an end piece 11 shaped like a round rod and axially extended from one end, namely, the rear end of the connection rod 12, and a presser ring 13 located on an opposite end, namely, the front end of the connection rod 12. The connection rod 12 has a diameter smaller than the end piece 11. The presser ring 13 is an annular member connected to the front end of the connection rod 12 at an angle, defining with the connection rod 12 a contained angle. Further, the presser ring 13 comprises a plurality of protruding portions 131 protruded from a front side thereof. In this embodiment, the protruding portions 131 have a semispherical shape, as shown in FIG. 3.

The handle 2 is a hollow cylindrical member comprising an insertion hole 21 and a rear opening 22 respectively located opposing front end and rear end thereof.

The vibrator 3 is mounted inside the handle 2, comprising a front accommodation hole 31 kept in axial alignment with the insertion hole 21 of the handle 2. The end piece 11 of the handle 2 can be inserted through the insertion hole 21 of the handle 2 and press-fitted into the front accommodation hole 31 of the vibrator 3.

The rechargeable battery 4 is mounted inside the handle 2 and aimed at the rear opening 22 of the handle 2.

The on/off switch 32 is mounted on the outside of the handle 2 and electrically connected with the vibrator 3 and the rechargeable battery 4, and operable to switch on/off the vibrator 3.

Referring to FIG. 4, the handheld pain reliever can be inserted into a battery charger 5, enabling the rechargeable battery 4 to be electrically charged.

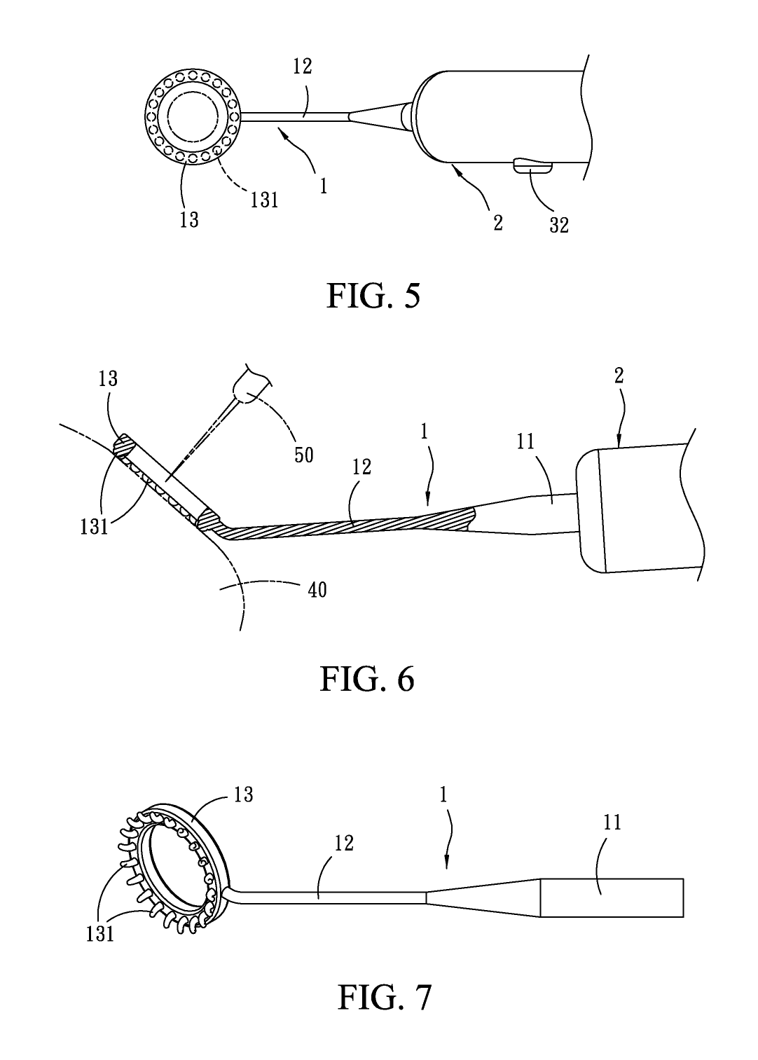

Referring to FIGS. 5 and 6, after the pressure bar 1, the handle 2, the vibrator 3, the on/off switch 32 and the rechargeable battery 4 are assembled, a physician can hold the handle 2 of the handheld pain reliever to press the protruding portions 131 of the presser ring 13 on an affected area 40 of a patient, and then switch on the on/off switch 32 to start up the vibrator 3, thereby vibrating the presser ring 13 against the patient's affected area 40. Thereafter, the physician can insert the needle of the syringe 50 into the skin of the patient's affected area 40 within the presser ring 13 to inject a medicine into the patient's body. By means of vibrating the patient's affected area 40 prior to injection, the patient feels less pain during injection.

FIG. 7 illustrates an alternate form of the present invention. This alternate form is substantially similar to that shown in FIGS. 2-6 with the exception of the protruding portions 131 of the presser ring 13 are shaped like an arched rod.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A handheld pain reliever, comprising:
a hollow handle comprising an insertion hole located on a front end thereof and a rear opening located on a rear end thereof;
a presser bar comprising a connection rod, an end piece axially extended from one end of said connection rod and inserted into said insertion hole, and a presser ring connected to an opposite end of said connection rod at an angle for pressing on an affected area of a patient, said presser ring comprising a plurality of protruding portions protruded from a front side thereof;
a vibrator mounted inside said hollow handle and adapted for vibrating said presser bar, said vibrator comprising a front accommodation hole kept in axial alignment with said insertion hole of said hollow handle and adapted for receiving said end piece of said presser bar;
a rechargeable battery mounted inside said hollow handle adjacent to said rear opening and adapted for providing electricity to said vibrator; and
an on/off switch mounted at said hollow handle and electrically connected with said vibrator and said rechargeable battery and operable to switch on/off said vibrator.

2. The handheld pain reliever as claimed in claim 1, further comprising a battery charger adapted for the insertion of the rear end of said hollow handle to electrically charge said rechargeable battery.

3. The handheld pain reliever as claimed in claim 1, wherein said protruding portions of said presser ring have a semispherical shape.

4. The handheld pain reliever as claimed in claim 1, wherein said protruding portions of said presser ring are shaped like an arched rod.

5. The handheld pain reliever as claimed in claim 1, wherein said end piece of said presser bar is shaped like a round rod.

6. The handheld pain reliever as claimed in claim 1, wherein said connection rod of said presser bar has a diameter smaller than said end piece.
